(19) United States
(12) Patent Application Publication
(10) Pub. No.: US 2024/0314764 A1
(43) Pub. Date: Sep. 19, 2024

(54) RESOURCE SELECTION FOR CONFIGURED GRANT

(71) Applicant: QUALCOMM Incorporated, San Diego, CA (US)

(72) Inventors: Ahmed ELSHAFIE, San Diego, CA (US); Diana MAAMARI, San Diego, CA (US); Muhammad Sayed Khairy ABDELGHAFFAR, San Jose, CA (US)

(21) Appl. No.: 18/183,678

(22) Filed: Mar. 14, 2023

(51) Int. Cl. H04W 72/121; H04W 72/02; H04W 72/23

(52) U.S. Cl. CPC H04W 72/121; H04W 72/02; H04W 72/23

(57) ABSTRACT

Various aspects of the present disclosure generally relate to wireless communication. In some aspects, a user equipment (UE) may receive configured grant (CG) group information. The UE may select a group of CG configurations based at least in part on the CG group information. The UE may select a CG configuration from the group of CG configurations. The UE may select resources within the CG configuration. The UE may transmit a communication using the resources. Numerous other aspects are described.

### FIELD OF THE DISCLOSURE

Aspects of the present disclosure generally relate to wireless communication and to techniques and apparatuses for resource selection for a configured grant.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving configured grant (CG) group information. The method may include selecting a group of CG configurations based at least in part on the CG group information. The method may include selecting a CG configuration from the group of CG configurations. The method may include selecting resources within the CG configuration. The method may include transmitting a communication using the resources.

Some aspects described herein relate to a method of wireless communication performed by a network entity. The method may include generating CG group information used for selecting a group of CGs, a CG configuration, and resources within the CG configuration. The method may include transmitting the CG group information.

Some aspects described herein relate to an apparatus for wireless communication at a UE. The apparatus may include a memory and one or more processors coupled to the memory, that, based at least in part on information stored in the memory, are configured to receive CG group information. The one or more processors may be configured to select a group of CG configurations based at least in part on the CG group information. The one or more processors may be configured to select a CG configuration from the group of CG configurations. The one or more processors may be configured to select resources within the CG configuration. The one or more processors may be configured to transmit a communication using the resources.

Some aspects described herein relate to an apparatus for wireless communication at a network entity. The apparatus may include a memory and one or more processors coupled to the memory, that, based at least in part on information stored in the memory, are configured to generate CG group information used for selecting a group of CGs, a CG configuration, and resources within the CG configuration. The one or more processors may be configured to transmit the CG group information.

Some aspects described herein relate to a non-transitory computer-readable medium that stores a set of instructions for wireless communication by a UE. The set of instructions, when executed by one or more processors of the UE, may cause the UE to receive CG group information. The set of instructions, when executed by one or more processors of the UE, may cause the UE to select a group of CG configurations based at least in part on the CG group information. The set of instructions, when executed by one or more processors of the UE, may cause the UE to select a CG configuration from the group of CG configurations. The set of instructions, when executed by one or more processors of the UE, may cause the UE to select resources within the CG configuration. The set of instructions, when executed by one or more processors of the UE, may cause the UE to transmit a communication using the resources.

Some aspects described herein relate to a non-transitory computer-readable medium that stores a set of instructions for wireless communication by a network entity. The set of instructions, when executed by one or more processors of the network entity, may cause the network entity to generate CG group information used for selecting a group of CGs, a CG configuration, and resources within the CG configuration. The set of instructions, when executed by one or more processors of the network entity, may cause the network entity to transmit the CG group information.

Some aspects described herein relate to an apparatus for wireless communication. The apparatus may include means for receiving CG group information. The apparatus may include means for selecting a group of CG configurations based at least in part on the CG group information. The apparatus may include means for selecting a CG configuration from the group of CG configurations. The apparatus may include means for selecting resources within the CG configuration. The apparatus may include means for transmitting a communication using the resources.

Some aspects described herein relate to an apparatus for wireless communication. The apparatus may include means for generating CG group information used for selecting a group of CGs, a CG configuration, and resources within the CG configuration. The apparatus may include means for transmitting the CG group information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of uplink configured grant (CG) communication, in accordance with the present disclosure.

FIG. 5 is a diagram illustrating an example associated with resource selection for CG, in accordance with the present disclosure.

FIG. 6 is a diagram illustrating an example associated with resource selection for CG, in accordance with the present disclosure.

FIG. 7 is a diagram illustrating an example of subresource selection, in accordance with the present disclosure.

FIG. 8 is a diagram illustrating an example process performed, for example, by a UE, in accordance with the present disclosure.

FIG. 9 is a diagram illustrating an example process performed, for example, by a network entity, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Resources for uplink communications by a user equipment (UE) may be granted according to a configuration. Such a resource may be referred to as a “configured grant” (CG). For example, CG communications may include periodic uplink communications that are configured for a UE, such that a network entity does not need to send separate downlink control information (DCI) to schedule each uplink communication, thereby conserving signaling overhead. With CG scheduling, resource allocation may be large, resource utilization may be high, interference in the uplink may increase, and power consumption may be higher. In some aspects, the UE may skip one or more CGs to conserve power. If one or more CGs are skipped, the UE may indicate, in CG uplink control information (CG-UCI), the one or more CGs that are skipped.

In some examples, a single DCI may schedule multiple uplink communications for a UE. A network entity may transmit a common DCI that schedules multiple communications (e.g., multiple downlink communications and/or multiple uplink communications) for each UE of a group of UEs. A UE, of the group of UEs, may receive the common DCI that schedules the multiple communications for each UE of the group of UEs. The UE may communicate with the network entity based at least in part on the multiple communications scheduled for the UE in the common DCI. If a common DCI or CG configuration schedules uplink communications for multiple UEs, there is some random resource selection within the selected grant/resource based on a randomization-like procedure at each UE. Furthermore, there can be durations of sparse uplink (UL) traffic and periodic arrivals (e.g., assigned UL CGs), and the UEs may or may not have data at some times. UEs may vary according to energy harvesting capability and may lack energy during some UL resources/occasions. Some resources, such as CG occasions, may be skipped when a portion of the CG occasion can still be used. As a result of variability of resource usage and the random resource selection, some resources of a group of UEs may be underutilized and this wastes signaling resources, reduces throughput, and increases latency.

According to various aspects described herein, the UE may receive CG group information for a group of UEs and select a group of CG configurations based at least in part on the CG group information. The UE may select a CG configuration from the group of CG configurations. The CG configuration may be referred to as a “resource set” and may include multiple resources. The UE may select resources from within the CG configuration and transmit a communication using the resources. By selecting a group of CG configurations, a CG configuration, and resources within the CG configuration, the UE 620 may better utilize CG resources for uplink communication. As a result, signaling resources are conserved, throughput is increased, and latency is reduced.

In some aspects, the network entity may indicate, to the group of UEs in the CG group information, a probability for resource selection that each UE can use for selecting resources, which enables a more efficient use of resources than random selection. If a UE has less data to transmit and can skip one or more CG occasions (or use less resources of a CG occasion), the UE may have a lower probability (e.g., less than 50%, less than 25%). If a UE has more data to transmit or has higher priority data, the UE may have a higher probability (e.g., greater than 50%, greater than 75%). A UE may have a low probability of using the resources if the packet delay budget (PDB) of the packet is still large. Consequently, other UEs can leverage those resources. The probability may be one of multiple selection parameters that the UE can use for resource selection. By using configured probabilities for resource selection, rather than random resource selection, signaling resources are further conserved, throughput is further increased, and latency is further reduced.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

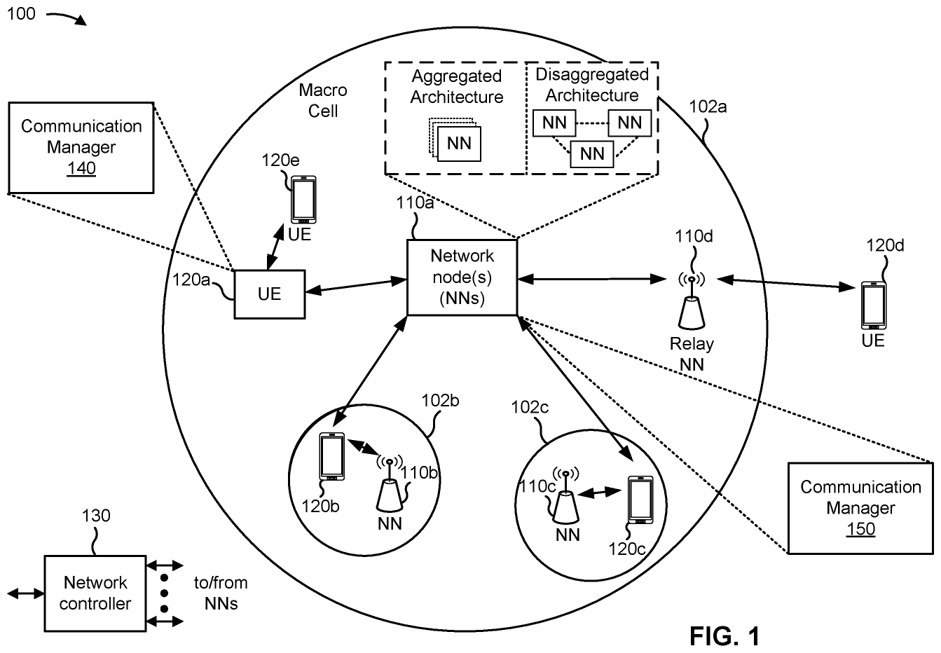

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (cMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHZ-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHZ) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., a UE 120) may include a communication manager 140. As described in more detail elsewhere herein, the communication manager 140 may receive CG group information. The communication manager 140 may select a group of CG configurations based at least in part on the CG group information. The communication manager 140 may select a CG configuration from the group of CG configurations. The communication manager 140 may select resources within the CG configuration. The communication manager 140 may transmit a communication using the resources. Additionally, or alternatively, the communication manager 140 may perform one or more other operations described herein.

In some aspects, a network entity (e.g., network node 110) may include a communication manager 150. As described in more detail elsewhere herein, the communication manager 150 may generate CG group information used for selecting a group of CGs, a CG configuration, and resources within the CG configuration. The communication manager 150 may transmit the CG group information. Additionally, or alternatively, the communication manager 150 may perform one or more other operations described herein.

As indicated above, FIG. 1 is provided as an example. Other examples may differ from what is described with regard to FIG. 1.

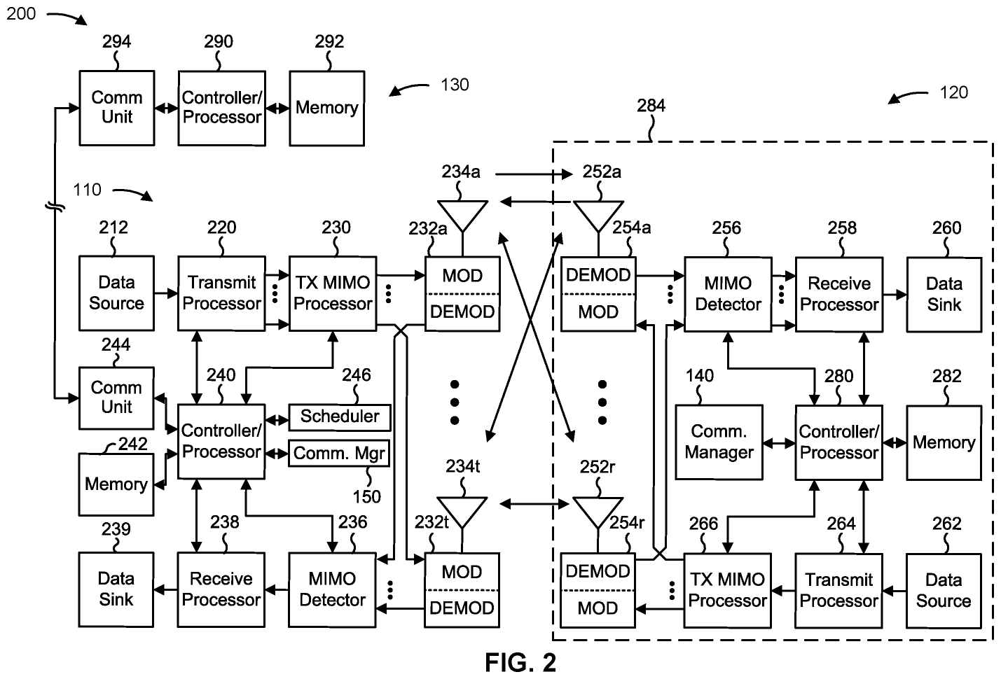

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

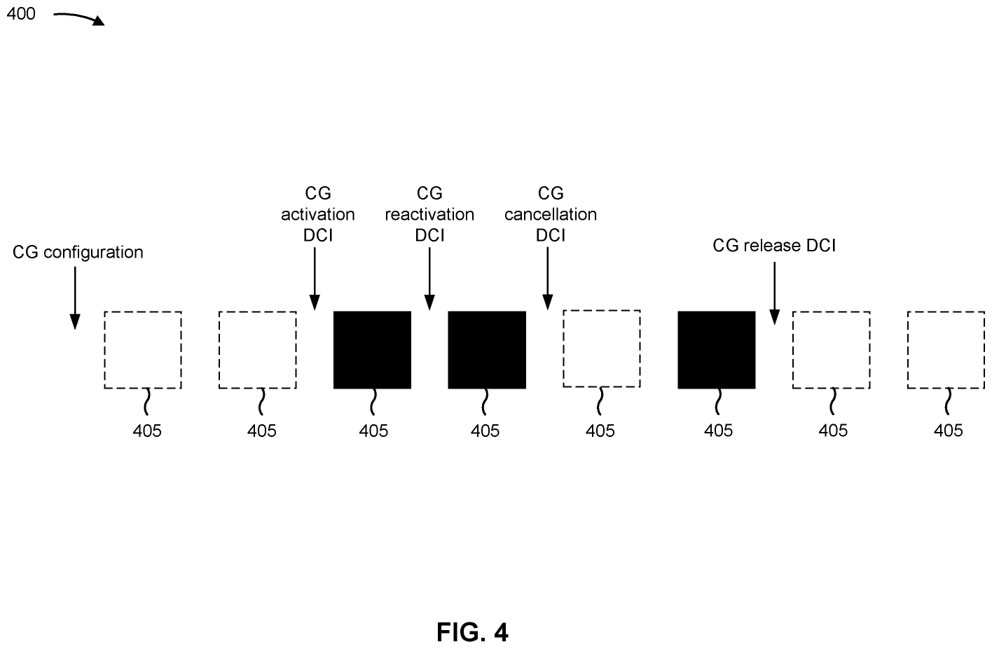

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-11).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-11).

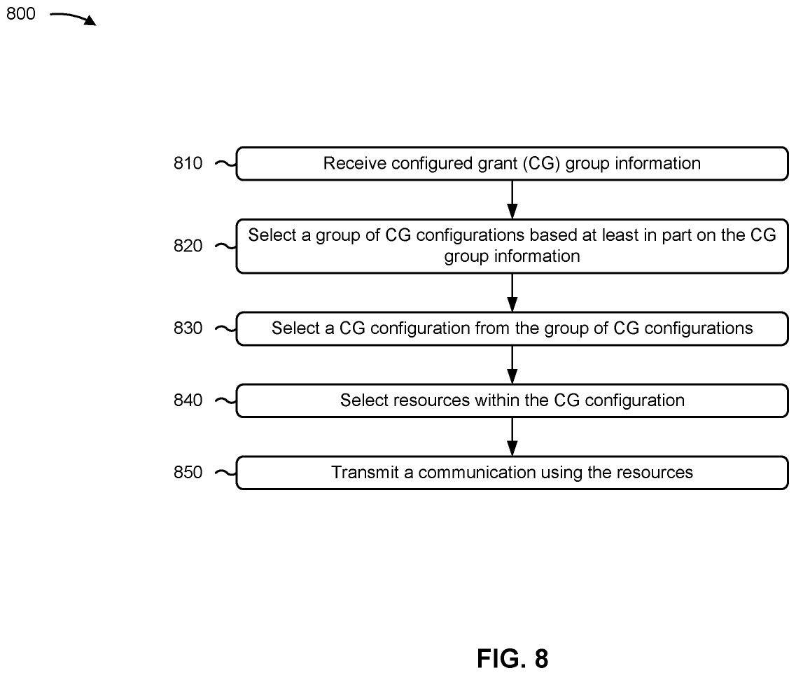

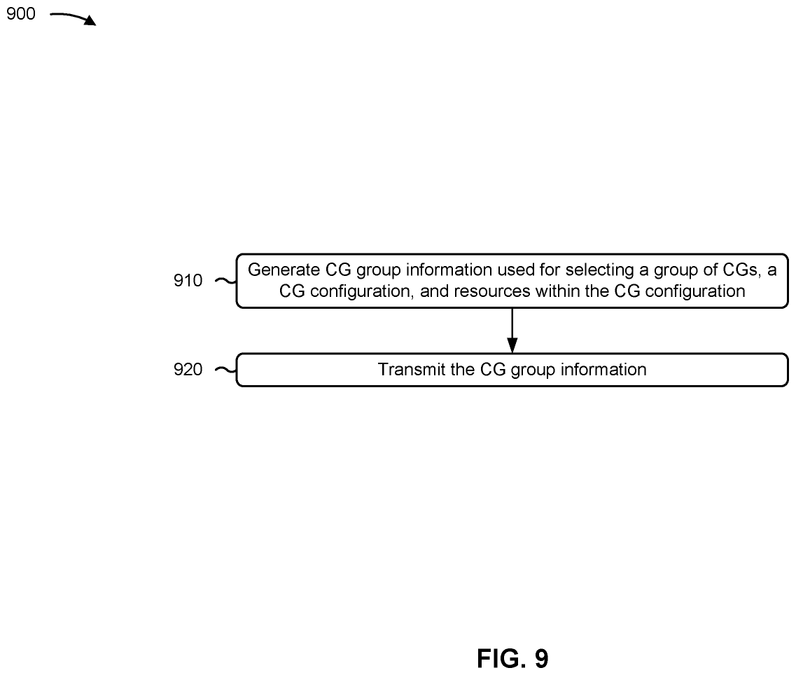

The controller/processor 240 of the network node 110, the controller/processor 280 of the UE 120, and/or any other component(s) of FIG. 2 may perform one or more techniques associated with selecting resources for CG, as described in more detail elsewhere herein. For example, the controller/processor 240 of the network node 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE (e.g., a UE 120) includes means for receiving CG group information; means for selecting a group of CG configurations based at least in part on the CG group information; means for selecting a CG configuration from the group of CG configurations; means for selecting resources within the CG configuration; and/or means for transmitting a communication using the resources. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., a network node 110) includes means for generating CG group information used for selecting a group of CGs, a CG configuration, and resources within the CG configuration; and/or means for transmitting the CG group information. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

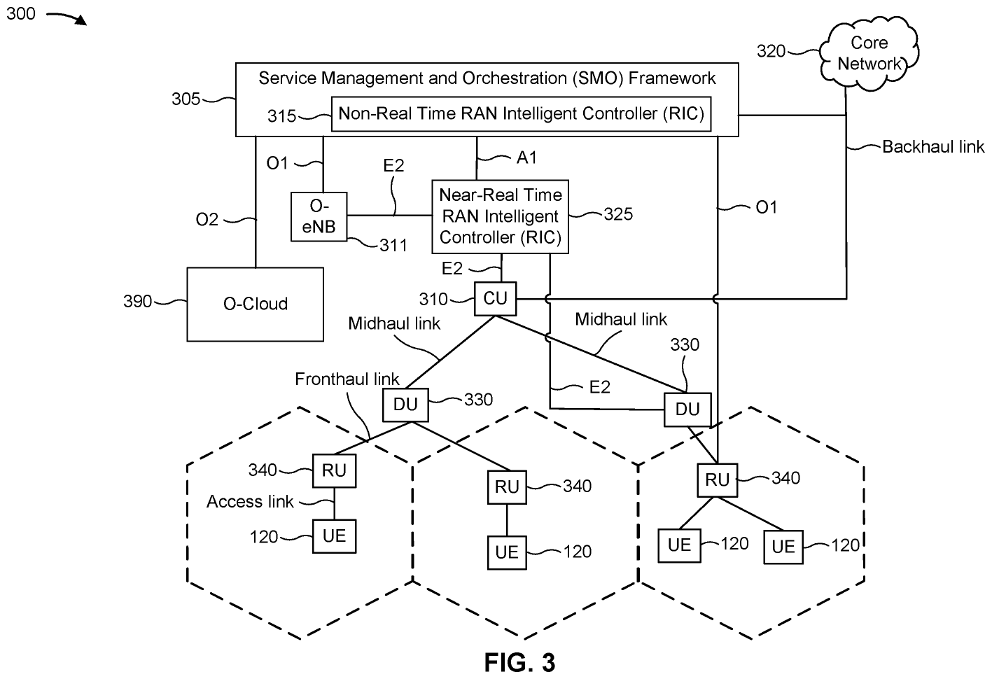

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram illustrating an example 400 of uplink CG communication, in accordance with the present disclosure.

In some aspects, physical resource blocks (PRBs) for uplink communications may be granted dynamically, such as with a scheduling request (SR) or a buffer status report (BSR). A UE may first transmit an SR on a physical uplink control channel (PUCCH), requesting radio resources in the uplink when the UE has pending data in its buffer. With periodic BSR reporting, the network entity knows the available buffer at the UE. The network entity then transmits an uplink grant DCI. The allocated resources are specified in the DCI for the UE to transmit a communication on the physical uplink shared channel (PUSCH).

Alternatively, PRBs for uplink communications may be granted according to a configuration. For example, CG communications may include periodic uplink communications that are configured for a UE, such that the network entity does not need to send separate DCI to schedule each uplink communication, thereby conserving signaling overhead.

As shown in example 400, a UE (e.g., UE 120) may be configured with a CG configuration for CG communications. For example, the UE may receive the CG configuration via an RRC message transmitted by a network entity (e.g., a network node 110). The CG configuration may indicate a resource allocation associated with CG uplink communications (e.g., in a time domain, frequency domain, spatial domain, and/or code domain) and a periodicity at which the resource allocation is repeated, resulting in periodically reoccurring scheduled CG occasions 405 for the UE. In some examples, the CG configuration may identify a resource pool or multiple resource pools that are available to the UE for an uplink transmission. The CG configuration may configure contention-free CG communications (e.g., where resources are dedicated for the UE to transmit uplink communications) or contention-based CG communications (e.g., where the UE contends for access to a channel in the configured resource allocation, such as by using a channel access procedure or a channel sensing procedure). A CG configuration may include a CG type 1 configuration, where the configuration and activation of a CG group of configurations is via RRC signaling.

A CG configuration may include a CG type 2 configuration, where the configuration is via RRC signaling and the activation is via DCI. The network entity may transmit CG activation DCI to the UE to activate the CG configuration for the UE. The network entity may indicate, in the CG activation DCI, communication parameters, such as an MCS, a resource block (RB) allocation, and/or antenna ports, for the CG PUSCH communications to be transmitted in the scheduled CG occasions 405. The UE may begin transmitting in the CG occasions 405 based at least in part on receiving the CG activation DCI. For example, beginning with a next scheduled CG occasion 405 subsequent to receiving the CG activation DCI, the UE may transmit a PUSCH communication in the scheduled CG occasions 405 using the communication parameters indicated in the CG activation DCI. The UE may refrain from transmitting in configured CG occasions 405 prior to receiving the CG activation DCI. The DCI may include a group identifier (ID) or multiple group IDs to activate multiple CG configurations, where all resources per CG configuration will be activated and the UE can select one.

The network entity may transmit CG reactivation DCI to the UE to change the communication parameters for the CG PUSCH communications. Based at least in part on receiving the CG reactivation DCI, the UE may begin transmitting in the scheduled CG occasions 405, using the communication parameters indicated in the CG reactivation DCI. For example, beginning with a next scheduled CG occasion 405 subsequent to receiving the CG reactivation DCI, the UE may transmit PUSCH communications in the scheduled CG occasions 405 based at least in part on the communication parameters indicated in the CG reactivation DCI.

In some cases, such as when the network entity needs to override a scheduled CG communication for a higher priority communication, the network entity may transmit CG cancellation DCI to the UE to temporarily cancel or deactivate one or more subsequent CG occasions 405 for the UE. The CG cancellation DCI may deactivate only a subsequent one CG occasion 405 or a subsequent N CG occasions 405 (where N is an integer). CG occasions 405 after the one or more (e.g., N) CG occasions 405 subsequent to the CG cancellation DCI may remain activated. Based at least in part on receiving the CG cancellation DCI, the UE may refrain from transmitting in the one or more (e.g., N) CG occasions 405 subsequent to receiving the CG cancellation DCI. As shown in example 400, the CG cancellation DCI cancels one subsequent CG occasion 405 for the UE. After the CG occasion 405 (or N CG occasions) subsequent to receiving the CG cancellation DCI, the UE may automatically resume transmission in the scheduled CG occasions 405.

The network entity may transmit CG release DCI to the UE to deactivate the CG configuration for the UE. The UE may stop transmitting in the scheduled CG occasions 405 based at least in part on receiving the CG release DCI. For example, the UE may refrain from transmitting in any scheduled CG occasions 405 until another CG activation DCI is received from the base station. Whereas the CG cancellation DCI may deactivate only a subsequent one CG occasion 405 or a subsequent N CG occasions 405, the CG release DCI deactivates all subsequent CG occasions 405 for a given CG configuration for the UE until the given CG configuration is activated again by a new CG activation DCI.

Another CG configuration may be a dynamic grant (DG) of a group of UL configurations that are activated. There may be multiple configurations per group of UL configurations, and multiple resources per configuration. With dynamic grants, RB allocation in the uplink may match the information bits of a communication and thus use less power. However, transmitting an SR and waiting for an uplink grant increases latency. With CG, RB allocation might be more than what is needed for the UE information bits, and more power may be consumed than necessary. The UE will have to pad the information bits such that all the allocated resources to the UE are used. If the UE has no information bits, (no packet convergence data protocol PDCP packets pending) or fewer information bits, the UE may still be required to transmit over the allocation resources.

With CG scheduling, resource allocation may be large, resource utilization may be high, interference in the uplink may increase, and power consumption may be higher. The higher power consumption may increase the thermal properties of the UE, which may be an important issue for extended reality (XR) devices or augmented reality (AR) devices.

In some aspects, a UE may skip or ignore a communication associated with a grant, whether a dynamic grant or a CG occasion. Otherwise, the UE transmits padded bits over the allocated resources (e.g., RBs), even though the information bits may not require the allocated number of RBs for transmission. The allocated number of RBs may be an overallocation. For example, the UE may receive a configuration (e.g., via RRC) that configures the UE to be able to skip a communication associated with a grant. The UE may receive the grant for an uplink communication. The UE may transmit the uplink communication (e.g., MAC protocol data unit (PDU)) if data is available. Power consumption may increase if the grant is larger. If no data is available, the UE may not transmit the uplink communication.

If one or more CGs are skipped, the UE may indicate, in CG-UCI, the one or more CGs that are skipped. When resource element (RE) mapping is performed, the CG-UCI may be multiplexed with PUSCH data, hybrid automatic repeat request (HARQ) feedback (e.g., acknowledgement (ACK), negative acknowledgement (NACK)), channel state information (CSI) part 1, and/or CSI part 2. The REs may be continuous in frequency or distributed. DMRS symbols may be skipped for HARQ, CG-UCI, or CSI mapping.

In some examples, a single DCI may schedule multiple uplink communications for a UE. For example, a single DCI (e.g., DCI 0_1) may schedule (or grant) PUSCH communications for a UE. That is, a single DCI may define resources for multiple PUSCH communications. Such scheduling of multiple PUSCH communications by a single DCI may be referred to as “multi-PUSCH scheduling.”

In some examples, a network entity may transmit a common DCI that schedules multiple communications (e.g., multiple downlink communications and/or multiple uplink communications) for each UE of a group of UEs. A UE, of the group of UEs, may receive the common DCI that schedules the multiple communications for each UE of the group of UEs. The UE may communicate with the network entity based at least in part on the multiple communications scheduled for the UE in the common DCI. As a result, a control signaling overhead is reduced, as compared with the network node transmitting separate DCI to each UE of the group of UEs.

If a common DCI or CG configuration schedules uplink communications for multiple UEs, there is some random resource selection within the selected grant/resource based on a randomization-like procedure at each UE. Furthermore, there can be durations of sparse UL traffic and periodic arrivals (e.g., assigned UL CGs), and the UEs may or may not have data at some times. UEs may vary according to energy harvesting capability and may lack energy during some UL resources/occasions. Some resources, such as CG occasions, may be skipped when a portion of the CG occasion can still be used. As a result of variability of resource usage and the random resource selection, some resources of a group of UEs may be underutilized and this wastes signaling resources, reduces throughput, and increases latency.

As indicated above, FIG. 4 is provided as an example. Other examples may differ from what is described with respect to FIG. 4.

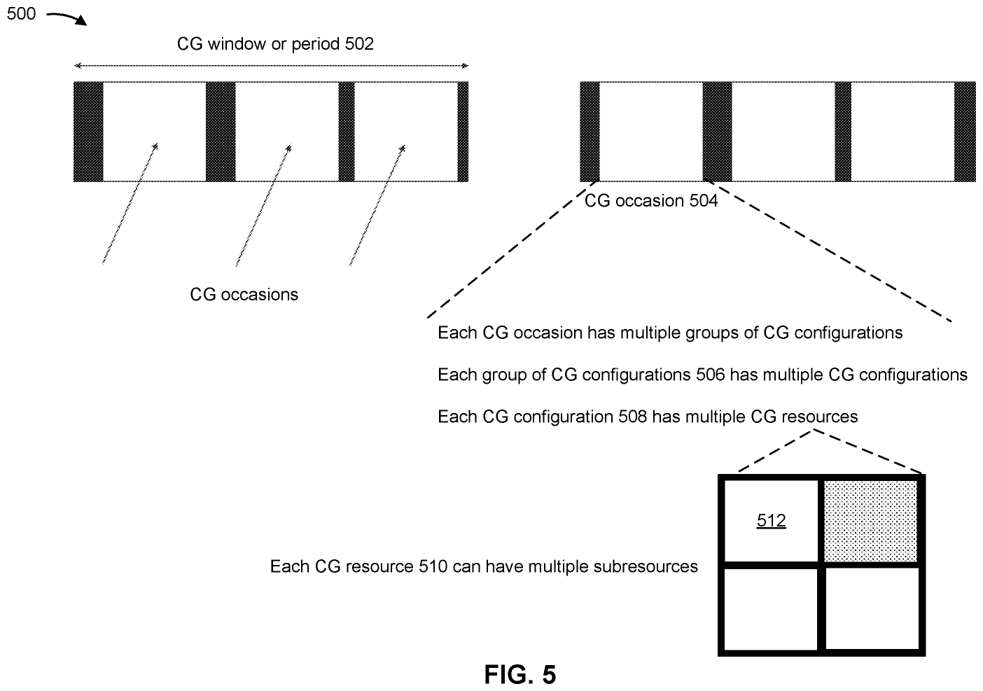

FIG. 5 is a diagram illustrating an example 500 associated with resource selection for CG, in accordance with the present disclosure.

According to various aspects described herein, the UE may receive CG group information for a group of UEs and select a group of CG configurations based at least in part on the CG group information. The UE may select a CG configuration from the group of CG configurations. The CG configuration may be referred to as a “resource set” and may include multiple resources. The UE may select resources from within the CG configuration and transmit a communication using the resources. By selecting a group of CG configurations, a CG configuration, and resources within the CG configuration, the UE 620 may better utilize CG resources for uplink communication. As a result, signaling resources are conserved, throughput is increased, and latency is reduced.

In some aspects, the network entity may indicate, to the group of UEs in the CG group information, a probability for resource selection that each UE can use for selecting resources, which enables a more efficient use of resources than random selection. If a UE has less data to transmit and can skip one or more CG occasions (or use fewer resources of a CG occasion), the UE may have a lower probability (e.g., less than 50%, less than 25%). If a UE has more data to transmit or has higher priority data, the UE may have a higher probability (e.g., greater than 50%, greater than 75%). A UE may have a low probability of using the resources if the PDB of the packet is still large. Consequently, other UEs can leverage those resources. The probability may be one of multiple selection parameters that the UE can use for resource selection. By using configured probabilities for resource selection, rather than random resource selection, signaling resources are further conserved, throughput is further increased, and latency is further reduced.

Example 500 shows a CG window or period 502 that includes multiple CG occasions. The CG window or period 502 may be a window or period of allocations. In some aspects, multiple windows or periods can be possible for DG, where the quantity of windows or periods may indicated by an RRC, a MAC control element (MAC CE), or DCI (including scheduling DCI). A CG occasion 504 may include multiple groups of CG configurations. Each group of CG configurations 506 may include multiple CG configurations. Each CG configuration 508 may include multiple CG resources. Each CG resource 510 can have multiple subresources, such as subresource 512.

In some aspects, for the CG occasion 504 in the CG window or period 502, the UE may select the group of CG configurations 506, select the CG configuration 508 from the group of CG configurations 506, and select the CG resource 510 within the CG configuration 508. The UE may transmit a communication using the CG resource 510.

A CG configuration may include a CG type 1 configuration, a CG type 2 configuration, or a DG configuration. Activation DCI may include a group ID or multiple group IDs to activate multiple CG configurations, where all resources per CG configuration may be activated and the UE may can select one CG configuration. The DCI may configure and activate all of the resources for the UE. For DG, configuration may be via RRC, a MAC CE, or DCI (including scheduling DCI) and activation may be through the DCI. In some aspects, a time domain resource allocation (TDRA) or a frequency domain resource allocation (FDRA) may be leveraged to activate or select how many configurations and resources are activated or selected for the UE. There may be defined tables and TDRA/FDRA indices can be used for the configurations and for the activations. Multiple windows or periods can be possible for DG, where the quantity of periods can be configured via RRC signaling, a MAC CE, or DCI (including scheduling DCI).

As indicated above, FIG. 5 is provided as an example. Other examples may differ from what is described with regard to FIG. 5.

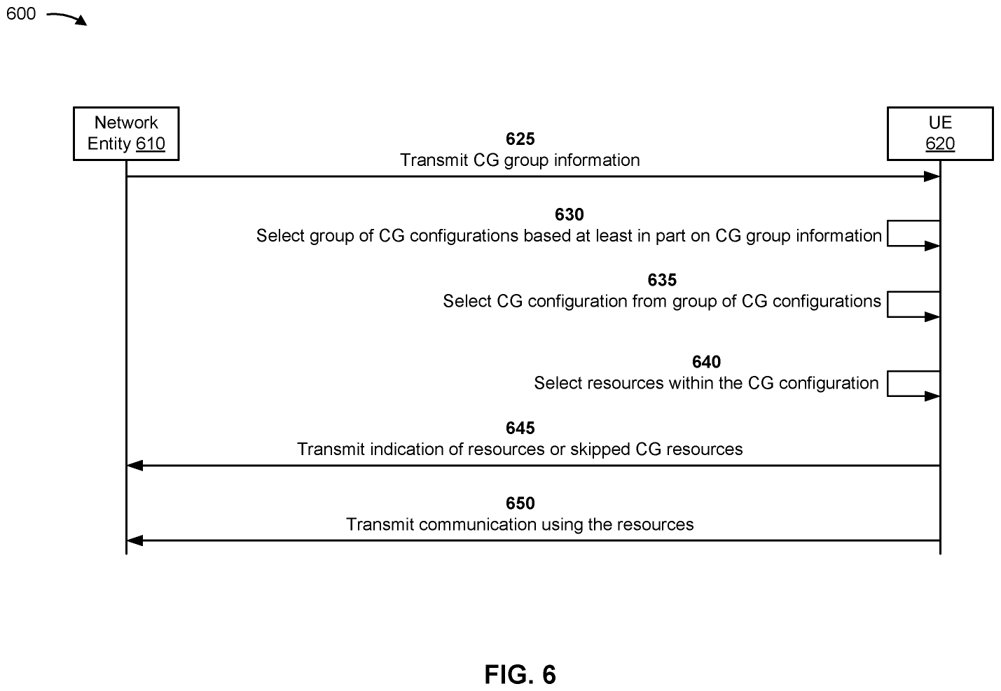

FIG. 6 is a diagram illustrating an example 600 associated with resource selection for CG, in accordance with the present disclosure. As shown in FIG. 5, a network entity 610 (e.g., a network node 110) and a UE 620 (e.g., a UE 120) may communicate with one another.

As shown by reference number 625, the network entity 610 may transmit CG group information. The CG group information may indicate groups of CG configurations, CG configuration information, and resources per CG configuration. The CG group information may include selection parameters, such as a probability for the UE 620 and for other UEs. The CG group information may include resource location parameters that indicate where the resources are located for a CG configuration. Resource location parameters may include a starting RB, a starting symbol, a quantity of RBs, and/or a quantity of symbols. Resource location parameters may include a priority, a quality of service (QOS), a remaining PDB, a randomization identifier, a CG index, and/or an MCS. Resource location parameters may include a DCI parameter, a Layer 1 or Layer 2 identifier, a frequency band, a bandwidth part (BWP) index, a scrambling identifier, or a component carrier (CC) index.

In some aspects, the network entity 610 may group CG configurations of a larger set of CG configurations into a first group of CG configurations. The first group of CG configurations may be identified by a group ID. The network entity 610 may activate the group of CG configurations with an activation commands. The activation command may be an RRC message or DCI, and may activate the group using the group ID. The network entity 610 may activate multiple groups at the same time using multiple group IDs.

As shown by reference number 630, the UE 620 may select a group of CG configurations based at least in part on the CG group information. The group of configurations may be associated with a CG occasion of a CG window or period. For example, there may be L₁ CG periods, with K₁ CG periods. There may be at least one CG occasion per CG window or period and at least one group of CG configurations within each CG occasion (L₂ within K₂). There may be at least one CG configuration in each CG group (L₃ within K₃) and at least one CG resource within each CG configuration (La within K₄).

In addition to selection based on, for example probability, there may be Layer 3 (L3)/Layer 2 (L2)/Layer 1 (L1) configurations as part of L3 (e.g., RRC) configuration of the CG windows or periods and some parameters may be provided in activation/deactivation DCI (for CG type 2), RRC activation (for CG type 1), or dynamic grant DCI in case of dynamic grant (e.g., 1 or more periods).

In some aspects, the UE 620 may select M resources out of all the N resources (across all periods, groups, configuration, resources), where M may be the quantity of transport blocks (TBs) the UE 620 has to transmit. There may be a configured procedure or a procedure defined in stored configuration information for resource selection based on parameters. In some aspects, a probability or procedure per level (CG window or period, group of CG configurations, CG configurations, CG resources) may be specified for each level.

As shown by reference number 635, the UE 620 may select a CG configuration from the group of CG configurations. As shown by reference number 640, the UE 620 may select resources within the CG configuration. The UE 620 may select resources based at least in part on a DCI format, a radio network temporary identifier (RNTI), a search space, or a field in DCI. In some aspects, the UE 620 may select resources based at least in part on a machine learning (ML) model that can use remaining PDB, transport block size (TBS), or other parameters for training and selection of resources and probabilities. In some aspects, the UE 620 may select one resource among all the resources per CG occasion or per CG window or period. The UE 620 may select only one CG occasion per CG window or period or select multiple CG occasions per CG window or period.

In some aspects, the UE 620 may select a quantity of resources (e.g., a quantity of CG occasions and a quantity of resources per CG occasion) based at least in part on one or more factors. These factors may include traffic conditions, such as an amount of data, an uplink BSR, or a quantity of TBs. The factors may include a priority, such as a PHY priority, a MAC priority, L1 or L2 priorities, and/or a QoS. The factors may include a delay parameter, such as a remaining PDB. The factors may also include a TBS and/or an energy profile of the UE 620 (e.g., power status, energy harvesting status, energy usage status).

As shown by reference number 645, in some aspects, the UE 620 may transmit an indication of resources or skipped CG resources. The indication may be directed to the network entity 610 and/or to other UEs. The indication may indicate CG periods to use (or skip) within a maximum quantity of periods that can be selected, CG occasions to use (or skip), CG configuration groups to use (or skip) within each CG occasion, CG configurations to use (or skip) within each CG configuration group, and/or CG resources to use (or skip) within each CG configuration.

As shown by reference number 650, the UE 620 may transmit a communication using the resources. By selecting a group of CG configurations of a CG occasion in a CG window or period, selecting a CG configuration, and selecting a CG resource (e.g., based on a probability or other selection parameter), the UE 620 may better utilize signaling resources when group DCI is involved.

In some aspects, the UE 620 may transmitting a request to halt group utilization of CG resources, based at least in part on a remaining PDB satisfying a PDB threshold or approaching the PDB. The network entity 610 may assign more dedicated collision-free resources. The indication may be an L1/L2/L3 message or a multiplexed L1/L2/L3 message (e.g., with CSI, a BSR, an SR, power headroom report (PHR), a random access channel (RACH) message, a data subscriber request (DSR), HARQ-ACK) from the UE 620 to the network entity 610. The network entity 610 may configure UE 620 via L1/L2/L3 signaling. The UE 620 may expect to receive the information from a CG configuration, in DCI that is groupcast, from an indication in DCI, or from an activation DCI of a CG.

In some aspects, the network entity 610 may assign a list or order of owners of the configured resources/occasions or dynamic resources. The owners may be UEs, and the list may be ordered by UE priority and/or by UE resource availability. The ownership can be indicated in an L1/L2/L3 indication (e.g., including in activation DCI in case of CG and scheduling DCI in case of dynamic grant of single or multiple PUSCH allocations). The network entity 610 may update the ownership from time to time based on knowledge of an energy status and/or data traffic of the UEs, traffic priority, a QoS of the traffic, a delay status (e.g., remaining PDB, time to wait), or a statistical delay report (SDR) (e.g., average/mean, variance, range, cumulative distribution function (CDF)). This may include the latest reported DSR and/or SDR. The order can be part of probability selection, or how the probabilities are determined per CG occasion or per resource within a CG occasion. The UE 620 may select resources or identify probabilities for resource selection based at least in part on the ordered list.

In some aspects, the UE 620 may indicate, as a response to DCI, the selected resources based at least in part on the result of the probability of selection. The network entity 610 may leverage the remaining resources so that they are not wasted. The network entity 610 may schedule more UEs with the resources or request UEs to adjust the probability of selection as needed.

In some aspects, the UE 620 may receive an indication of a power control adjustment for a non-orthogonal multiple access (NOMA) scheme for the resources. The UE 620 may receive an indication to select the resources based at least in part on avoiding overlapping resources. For example, if two UEs select the same resources, the 610 may indicate some power control to adjust the NOMA scheme or request UEs to avoid certain overlapped resources (especially if more than 2 UEs selected the same resources). This can be a way to reduce collisions, especially if UEs have important data, which may be determined based on BSR reports and/or DSR/SDR reports.

As indicated above, FIG. 6 is provided as an example. Other examples may differ from what is described with regard to FIG. 6.

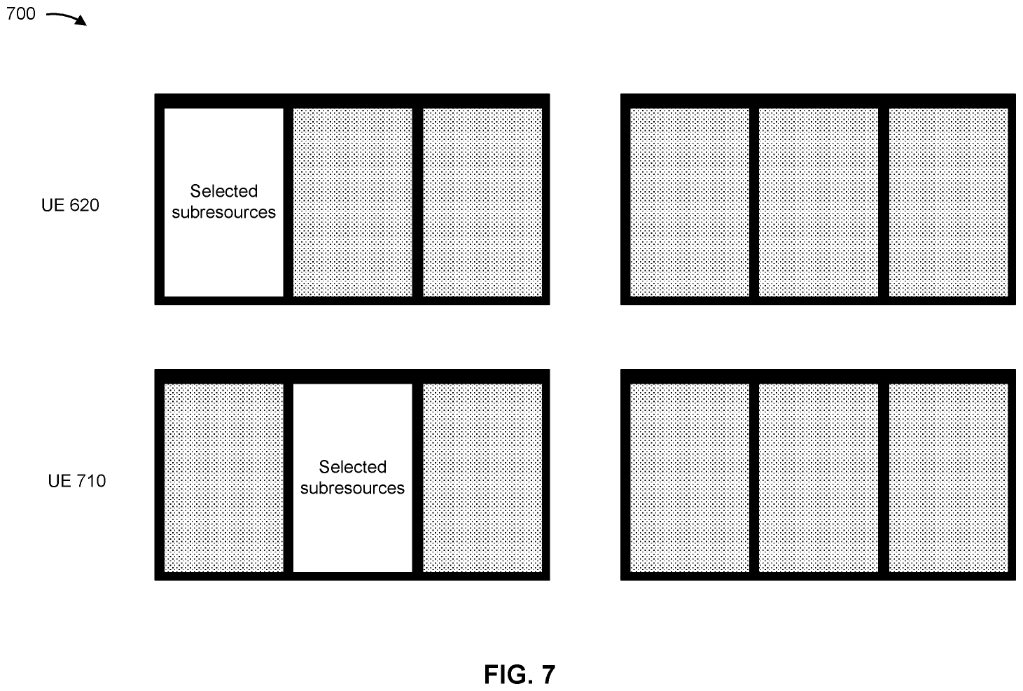

FIG. 7 is a diagram illustrating an example 700 of subresource selection, in accordance with the present disclosure.

In some aspects, the network entity 610 may define a subprobability per resource such that after selecting the resource with probability p, the UE 620 may select a set of resources (e.g., RBs and OFDM symbols) that fits the TB size. In some aspects, the UE 620 may divide the resources into blocks that could be defined by RRC/MAC CE or constructed by the UE 620 such that the UE 620 selects one block with probability p2. In some aspects, the UE 620 may select subresources within a resource based at least in part on a selection parameter (e.g., subprobability). The UE 620 may jointly select the resource and the subresource that fits the TB.

Example 700 shows subresources in each resource for UE 620 and subresources in each resource for another UE 710. In some aspects, each UE in a group of UEs may select different subresources of an UL grant, as shown by example 700.

As indicated above, FIG. 7 is provided as an example. Other examples may differ from what is described with regard to FIG. 7.

FIG. 8 is a diagram illustrating an example process 800 performed, for example, by a UE, in accordance with the present disclosure. Example process 800 is an example where the UE (e.g., UE 120, UE 620) performs operations associated with resource selection for CG.

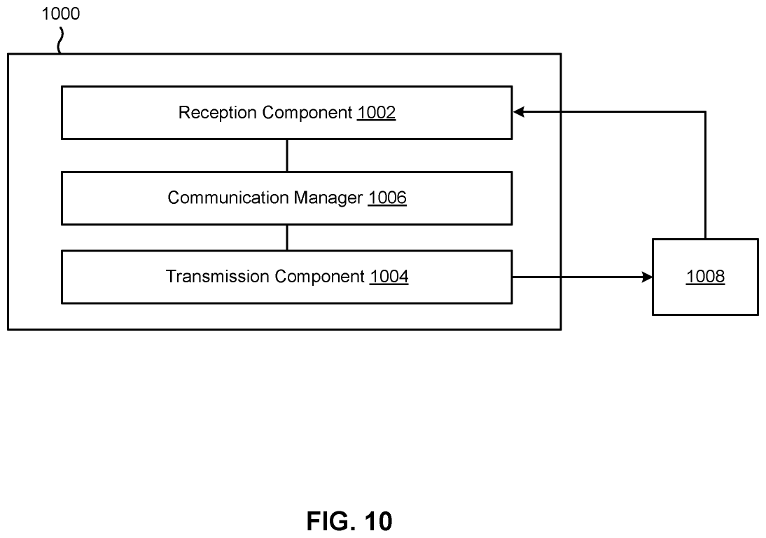

As shown in FIG. 8, in some aspects, process 800 may include receiving CG group information (block 810). For example, the UE (e.g., using reception component 1002 and/or communication manager 1006, depicted in FIG. 10) may receive CG group information, as described above.

As further shown in FIG. 8, in some aspects, process 800 may include selecting a group of CG configurations based at least in part on the CG group information (block 820). For example, the UE (e.g., using communication manager 1006, depicted in FIG. 10) may select a group of CG configurations based at least in part on the CG group information, as described above.

As further shown in FIG. 8, in some aspects, process 800 may include selecting a CG configuration from the group of CG configurations (block 830). For example, the UE (e.g., using communication manager 1006, depicted in FIG. 10) may select a CG configuration from the group of CG configurations, as described above.

As further shown in FIG. 8, in some aspects, process 800 may include selecting resources within the CG configuration (block 840). For example, the UE (e.g., using communication manager 1006, depicted in FIG. 10) may select resources within the CG configuration, as described above.

As further shown in FIG. 8, in some aspects, process 800 may include transmitting a communication using the resources (block 850). For example, the UE (e.g., using transmission component 1004 and/or communication manager 1006, depicted in FIG. 10) may transmit a communication using the resources, as described above.

Process 800 may include additional aspects, such as any single aspect or any combination of aspects described below and/or in connection with one or more other processes described elsewhere herein.

In a first aspect, selecting the resources comprises selecting the resources within the CG configuration based at least in part on one or more selection parameters.

In a second aspect, alone or in combination with the first aspect, the one or more selection parameters comprise a probability of selection as a resource.

In a third aspect, alone or in combination with one or more of the first and second aspects, process 800 includes receiving an indication of the probability.

In a fourth aspect, alone or in combination with one or more of the first through third aspects, the probability is associated with a remaining PDB.

In a fifth aspect, alone or in combination with one or more of the first through fourth aspects, selecting the resources includes selecting the resources based at least in part on a DCI format, an RNTI, a search space, or a field in DCI.

In a sixth aspect, alone or in combination with one or more of the first through fifth aspects, process 800 includes transmitting an indication of the resources.

In a seventh aspect, alone or in combination with one or more of the first through sixth aspects, process 800 includes transmitting an indication of CG resources, other than the selected resources, that are skipped.

In an eighth aspect, alone or in combination with one or more of the first through seventh aspects, process 800 includes receiving an indication of skipped CG resources, where selecting the resources comprises selecting the resources based at least in part on the skipped CG resources.

In a ninth aspect, alone or in combination with one or more of the first through eighth aspects, process 800 includes transmitting a request to halt group utilization of CG resources, based at least in part on a remaining PDB satisfying a PDB threshold.

In a tenth aspect, alone or in combination with one or more of the first through ninth aspects, process 800 includes receiving an ordered list of resource owners, where selecting the CG configuration and selecting the resources comprises selecting the CG configuration and selecting the resources based at least in part on the ordered list of resource owners.

In an eleventh aspect, alone or in combination with one or more of the first through tenth aspects, process 800 includes receiving an updated ordered list of resource owners.

In a twelfth aspect, alone or in combination with one or more of the first through eleventh aspects, process 800 includes receiving an indication of a power control adjustment for a NOMA scheme for the resources.

In a thirteenth aspect, alone or in combination with one or more of the first through twelfth aspects, process 800 includes receiving an indication to select the resources based at least in part on avoiding overlapping resources.

In a fourteenth aspect, alone or in combination with one or more of the first through thirteenth aspects, process 800 includes selecting a subresource for one of the resources.

In a fifteenth aspect, alone or in combination with one or more of the first through fourteenth aspects, selecting the resources comprises selecting the resources based at least in part on a probability of selection for the resources, and wherein selecting the subresource comprises selecting the subresource based at least in part on a subprobability per resource.

In a sixteenth aspect, alone or in combination with one or more of the first through fifteenth aspects, selecting the subresource includes selecting the subresource based at least in part on a resource location parameter.

In a seventeenth aspect, alone or in combination with one or more of the first through sixteenth aspects, the resource location parameter comprises one or more of a starting RB, a starting symbol, a quantity of RBs, or a quantity of symbols.

In an eighteenth aspect, alone or in combination with one or more of the first through seventeenth aspects, the resource location parameter comprises one or more of a priority, a QoS, a remaining PDB, a randomization identifier, a CG index, or an MCS.

In a nineteenth aspect, alone or in combination with one or more of the first through eighteenth aspects, the resource location parameter includes one or more of a DCI parameter, an L1 or L2 identifier, a frequency band, a BWP index, a scrambling identifier, or a CC index.

In a twentieth aspect, alone or in combination with one or more of the first through nineteenth aspects, process 800 includes dividing the resources into a block based at least in part on a TB to be mapped to the resources, and selecting one or more blocks based at least in part on a quantity of TBs to transmit.

In a twenty-first aspect, alone or in combination with one or more of the first through twentieth aspects, selecting the resources comprises selecting the resources based at least in part on an ML model and one or more of a remaining PDB or a TBS.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., a network node 110, network entity 610) performs operations associated with resource selection for CG.

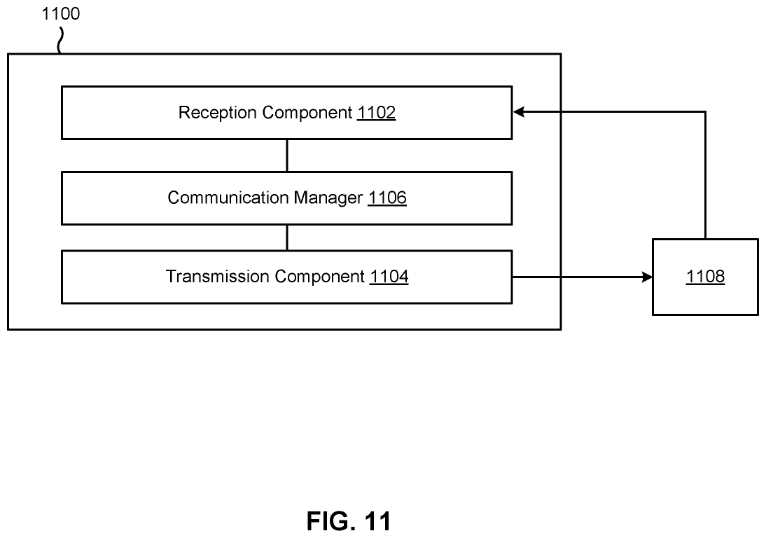

As shown in FIG. 9, in some aspects, process 900 may include generating CG group information used for selecting a group of CGs, a CG configuration, and resources within the CG configuration (block 910). For example, the network entity (e.g., using communication manager 1106, depicted in FIG. 11) may generate CG group information used for selecting a group of CGs, a CG configuration, and resources within the CG configuration, as described above.

As further shown in FIG. 9, in some aspects, process 900 may include transmitting the CG group information (block 920). For example, the network entity (e.g., using transmission component 1104 and/or communication manager 1106, depicted in FIG. 11) may transmit the CG group information, as described above.

Process 900 may include additional aspects, such as any single aspect or any combination of aspects described below and/or in connection with one or more other processes described elsewhere herein.

In a first aspect, process 900 includes transmitting an indication of a probability of selection of resources.

In a second aspect, alone or in combination with the first aspect, process 900 includes receiving an indication of the resources selected from within the CG configuration.

In a third aspect, alone or in combination with one or more of the first and second aspects, process 900 includes receiving a request to halt group utilization of CG resources, based at least in part on a remaining PDB satisfying a PDB threshold, and adjusting scheduling or skipping of CG resources based at least in part on the request.

In a fourth aspect, alone or in combination with one or more of the first through third aspects, process 900 includes transmitting an ordered list of resource owners.

In a fifth aspect, alone or in combination with one or more of the first through fourth aspects, process 900 includes transmitting an indication of a power control adjustment for a NOMA scheme for the resources or an indication to select the resources based at least in part on avoiding overlapping resources.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE (e.g., UE 120, UE 620), or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 140 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 1-7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive CG group information. The communication manager 1006 may select a group of CG configurations based at least in part on the CG group information. The communication manager 1006 may select a CG configuration from the group of CG configurations. The communication manager 1006 may select resources within the CG configuration. The transmission component 1004 may transmit a communication using the resources.

The reception component 1002 may receive an indication of the probability. The transmission component 1004 may transmit an indication of the resources. The transmission component 1004 may transmit an indication of CG resources, other than the selected resources, that are skipped.

The reception component 1002 may receive an indication of skipped CG resources, and the communication manager 1006 may select the resources based at least in part on the skipped CG resources. The transmission component 1004 may transmit a request to halt group utilization of CG resources, based at least in part on a remaining PDB satisfying a PDB threshold. The reception component 1002 may receive an ordered list of resource owners, and the communication manager 1006 may select the CG configuration and select the resources based at least in part on the ordered list of resource owners.

The reception component 1002 may receive an updated ordered list of resource owners. The reception component 1002 may receive an indication of a power control adjustment for a NOMA scheme for the resources. The reception component 1002 may receive an indication to select the resources based at least in part on avoiding overlapping resources. The communication manager 1006 may select a subresource for one of the resources.

The communication manager 1006 may divide the resources into a block based at least in part on a TB to be mapped to the resources. The communication manager 1006 may select one or more blocks based at least in part on a quantity of TBs to transmit.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network entity (e.g., network node 110, network entity 610), or a network entity may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 1-7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network entity described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network entity described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the network entity described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The communication manager 1106 may generate CG group information used for selecting a group of CGs, a CG configuration, and resources within the CG configuration. The transmission component 1104 may transmit the CG group information.

The transmission component 1104 may transmit an indication of a probability of selection of resources. The reception component 1102 may receive an indication of the resources selected from within the CG configuration. The reception component 1102 may receive a request to halt group utilization of CG resources, based at least in part on a remaining PDB satisfying a PDB threshold.

The communication manager 1106 may adjust scheduling or skipping of CG resources based at least in part on the request. The transmission component 1104 may transmit an ordered list of resource owners. The transmission component 1104 may transmit an indication of a power control adjustment for a NOMA scheme for the resources or an indication to select the resources based at least in part on avoiding overlapping resources.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving configured grant (CG) group information; selecting a group of CG configurations based at least in part on the CG group information; selecting a CG configuration from the group of CG configurations; selecting resources within the CG configuration; and transmitting a communication using the resources.

Aspect 2: The method of Aspect 1, wherein selecting the resources comprises selecting the resources within the CG configuration based at least in part on one or more selection parameters.

Aspect 3: The method of Aspect 2, wherein the one or more selection parameters comprise a probability of selection as a resource.

Aspect 4: The method of Aspect 3, further comprising receiving an indication of the probability.

Aspect 5: The method of Aspect 3, wherein the probability is associated with a remaining packet delay budget.

Aspect 6: The method of any of Aspects 1-5, wherein selecting the resources includes selecting the resources based at least in part on a downlink control information (DCI) format, a radio network temporary identifier, a search space, or a field in DCI.

Aspect 7: The method of any of Aspects 1-6, further comprising transmitting an indication of the resources.

Aspect 8: The method of any of Aspects 1-7, further comprising transmitting an indication of CG resources, other than the selected resources, that are skipped.

Aspect 9: The method of any of Aspects 1-8, further comprising receiving an indication of skipped CG resources, wherein selecting the resources comprises selecting the resources based at least in part on the skipped CG resources.

Aspect 10: The method of any of Aspects 1-9, further comprising transmitting a request to halt group utilization of CG resources, based at least in part on a remaining packet delay budget (PDB) satisfying a PDB threshold.

Aspect 11: The method of any of Aspects 1-10, further comprising receiving an ordered list of resource owners, wherein selecting the CG configuration and selecting the resources comprises selecting the CG configuration and selecting the resources based at least in part on the ordered list of resource owners.

Aspect 12: The method of Aspect 11, further comprising receiving an updated ordered list of resource owners.

Aspect 13: The method of any of Aspects 1-12, further comprising receiving an indication of a power control adjustment for a non-orthogonal multiple access scheme for the resources.

Aspect 14: The method of any of Aspects 1-13, further comprising receiving an indication to select the resources based at least in part on avoiding overlapping resources.

Aspect 15: The method of any of Aspects 1-14, further comprising selecting a subresource for one of the resources.

Aspect 16: The method of Aspect 15, wherein selecting the resources comprises selecting the resources based at least in part on a probability of selection for the resources, and wherein selecting the subresource comprises selecting the subresource based at least in part on a subprobability per resource.

Aspect 17: The method of Aspect 15, wherein selecting the subresource includes selecting the subresource based at least in part on a resource location parameter.

Aspect 18: The method of Aspect 17, wherein the resource location parameter comprises one or more of a starting resource block (RB), a starting symbol, a quantity of RBs, or a quantity of symbols.

Aspect 19: The method of Aspect 17, wherein the resource location parameter comprises one or more of a priority, a quality of service, a remaining packet delay budget, a randomization identifier, a CG index, or a modulation and coding scheme.

Aspect 20: The method of Aspect 17, wherein the resource location parameter includes one or more of a downlink control information parameter, a Layer 1 or Layer 2 identifier, a frequency band, a bandwidth part index, a scrambling identifier, or a component carrier index.

Aspect 21: The method of Aspect 15, further comprising: dividing the resources into a block based at least in part on a transport block (TB) to be mapped to the resources; and selecting one or more blocks based at least in part on a quantity of TBs to transmit.

Aspect 22: The method of any of Aspects 1-21, wherein selecting the resources comprises selecting the resources based at least in part on a machine learning model and one or more of a remaining packet delay budget or a transport block size.

Aspect 23: A method of wireless communication performed by a network entity, comprising: generating configured grant (CG) group information used for selecting a group of CGs, a CG configuration, and resources within the CG configuration; and transmitting the CG group information.

Aspect 24: The method of Aspect 23, further comprising transmitting an indication of a probability of selection of resources.

Aspect 25: The method of any of Aspects 23-24, further comprising receiving an indication of the resources selected from within the CG configuration.

Aspect 26: The method of any of Aspects 23-25, further comprising: receiving a request to halt group utilization of CG resources, based at least in part on a remaining packet delay budget (PDB) satisfying a PDB threshold; and adjusting scheduling or skipping of CG resources based at least in part on the request.

Aspect 27: The method of any of Aspects 23-26, further comprising transmitting an ordered list of resource owners.

Aspect 28: The method of any of Aspects 23-27, further comprising transmitting an indication of a power control adjustment for a non-orthogonal multiple access scheme for the resources or an indication to select the resources based at least in part on avoiding overlapping resources.

Aspect 29: An apparatus for wireless communication at a device, comprising a processor; memory coupled with the processor; and instructions stored in the memory and executable by the processor to cause the apparatus to perform the method of one or more of Aspects 1-28.

Aspect 30: A device for wireless communication, comprising a memory and one or more processors coupled to the memory, the one or more processors configured to perform the method of one or more of Aspects 1-28.

Aspect 31: An apparatus for wireless communication, comprising at least one means for performing the method of one or more of Aspects 1-28.

Aspect 32: A non-transitory computer-readable medium storing code for wireless communication, the code comprising instructions executable by a processor to perform the method of one or more of Aspects 1-28.

Aspect 33: A non-transitory computer-readable medium storing a set of instructions for wireless communication, the set of instructions comprising one or more instructions that, when executed by one or more processors of a device, cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, that, based at least in part on information stored in the memory, are configured to:
receive configured grant (CG) group information;
select a group of CG configurations based at least in part on the CG group information;
select a CG configuration from the group of CG configurations;
select resources within the CG configuration; and
transmit a communication using the resources.

2. The apparatus of claim 1, wherein the one or more processors, to select the resources, are configured to select the resources within the CG configuration based at least in part on one or more selection parameters.

3. The apparatus of claim 2, wherein the one or more selection parameters comprise a probability of selection as a resource.

4. The apparatus of claim 3, wherein the one or more processors are configured to receive an indication of the probability.

5. The apparatus of claim 3, wherein the probability is associated with a remaining packet delay budget.

6. The apparatus of claim 1, wherein the one or more processors, to select the resources, are configured to select the resources based at least in part on a downlink control information (DCI) format, a radio network temporary identifier, a search space, or a field in DCI.

7. The apparatus of claim 1, wherein the one or more processors are configured to transmit an indication of the resources.

8. The apparatus of claim 1, wherein the one or more processors are configured to transmit an indication of CG resources, other than the selected resources, that are skipped.

9. The apparatus of claim 1, wherein the one or more processors are configured to receive an indication of skipped CG resources, and wherein the one or more processors, to select the resources, are configured to select the resources based at least in part on the skipped CG resources.

10. The apparatus of claim 1, wherein the one or more processors are configured to transmit a request to halt group utilization of CG resources, based at least in part on a remaining packet delay budget (PDB) satisfying a PDB threshold.

11. The apparatus of claim 1, wherein the one or more processors are configured to receive an ordered list of resource owners, and wherein the one or more processors, to select the CG configuration and select the resources, are configured to select the CG configuration and select the resources based at least in part on the ordered list of resource owners.

12. The apparatus of claim 11, wherein the one or more processors are configured to receive an updated ordered list of resource owners.

13. The apparatus of claim 1, wherein the one or more processors are configured to receive an indication of a power control adjustment for a non-orthogonal multiple access scheme for the resources.

14. The apparatus of claim 1, wherein the one or more processors are configured to receive an indication to select the resources based at least in part on avoiding overlapping resources.

15. The apparatus of claim 1, wherein the one or more processors are configured to select a subresource for one of the resources.

16. The apparatus of claim 15, wherein the one or more processors, to select the resources, are configured to select the resources based at least in part on a probability of selection for the resources, and wherein the one or more processors, to select the subresource, are configured to select the subresource based at least in part on a subprobability per resource.

17. The apparatus of claim 15, wherein the one or more processors, to select the subresource, are configured to select the subresource based at least in part on a resource location parameter.

18. The apparatus of claim 17, wherein the resource location parameter comprises one or more of a starting resource block (RB), a starting symbol, a quantity of RBs, or a quantity of symbols.

19. The apparatus of claim 17, wherein the resource location parameter comprises one or more of a priority, a quality of service, a remaining packet delay budget, a randomization identifier, a CG index, or a modulation and coding scheme.

20. The apparatus of claim 17, wherein the resource location parameter includes one or more of a downlink control information parameter, a Layer 1 or Layer 2 identifier, a frequency band, a bandwidth part index, a scrambling identifier, or a component carrier index.

21. The apparatus of claim 15, wherein the one or more processors are configured to:
divide the resources into a block based at least in part on a transport block (TB) to be mapped to the resources; and
select one or more blocks based at least in part on a quantity of TBs to transmit.

22. The apparatus of claim 1, wherein the one or more processors, to select the resources, are configured to select the resources based at least in part on a machine learning model and one or more of a remaining packet delay budget or a transport block size.

23. An apparatus for wireless communication at a network entity, comprising:
a memory; and
one or more processors, coupled to the memory, that, based at least in part on information stored in the memory, are configured to:
generate configured grant (CG) group information used for selecting a group of CGs, a CG configuration, and resources within the CG configuration; and
transmit the CG group information.

24. The apparatus of claim 23, wherein the one or more processors are configured to transmit an indication of a probability of selection of resources.

25. The apparatus of claim 23, wherein the one or more processors are configured to receive an indication of the resources selected from within the CG configuration.

26. The apparatus of claim 23, wherein the one or more processors are configured to:
receive a request to halt group utilization of CG resources, based at least in part on a remaining packet delay budget (PDB) satisfying a PDB threshold; and
adjust scheduling or skipping of CG resources based at least in part on the request.

27. The apparatus of claim 23, wherein the one or more processors are configured to transmit an ordered list of resource owners.

28. The apparatus of claim 23, wherein the one or more processors are configured to transmit an indication of a power control adjustment for a non-orthogonal multiple access scheme for the resources or an indication to select the resources based at least in part on avoiding overlapping resources.

29. A method of wireless communication performed by a user equipment (UE), comprising:
receiving configured grant (CG) group information;
selecting a group of CG configurations based at least in part on the CG group information;
selecting a CG configuration from the group of CG configurations;
selecting resources within the CG configuration; and
transmitting a communication using the resources.

30. The method of claim 29, wherein selecting the resources comprises selecting the resources within the CG configuration based at least in part on one or more selection parameters, and wherein the one or more selection parameters comprise a probability of selection as a resource.
